(19) United States
(12) Patent Application Publication
(10) Pub. No.: US 2010/0101507 A1
(43) Pub. Date: Apr. 29, 2010

(54) WATER HEATERS WITH FUEL LINE AND DOOR ASSEMBLY

(76) Inventors: Emadeddin Y. Tanbour, Johnson City, TN (US); Rodney R. Syler, Franklin, TN (US); Mark A. Murphy, Nashville, TN (US); Marcus E. McAnally, Nashville, TN (US)

Correspondence Address: MICHAEL BEST & FRIEDRICH LLP, 100 E WISCONSIN AVENUE, Suite 3300, MILWAUKEE, WI, 53202, US

(21) Appl. No.: 12/260,233

(22) Filed: Oct. 29, 2008

(51) Int. Cl. F24H 1/34; F16L 9/14

(52) U.S. Cl. 122/18.5; 138/177

(57) ABSTRACT

A water heater includes a water container, a combustion chamber having an opening that may be covered by a door and located adjacent the water container, a burner associated with the combustion chamber and arranged to combust fuel to heat water in the water container, and a control valve for regulating fuel flow from an external fuel source. A fuel line extends between the control valve and the burner, the fuel line has a first substantially rigid portion connected to the control valve, a second interior portion extending from the door to the burner and a third flexible portion fixedly connected to both of the first and second portions.

### TECHNICAL FIELD

The technology in this disclosure relates to water heaters, particularly to water heaters that have door assemblies, such as those for water heater combustion chambers.

### BACKGROUND

Gas fired water heaters of the storage type traditionally have a water container placed above or adjacent to a combustion chamber and burner assembly. The burner assembly is controlled by a gas control valve which may be responsive to user input, such as a temperature setting. The burner assembly may have a main gas line extending from the gas control valve, through the combustion chamber wall or door, and to the burner. Gas lines have been constructed using various configurations and materials. By way of example, rigid tubing has been used where possible and in some cases threaded fittings are used to connect the rigid tubing to flexible tubing.

It could be beneficial to provide a gas line that was simple, compact, durable, tamper-resistant and economical to construct.

### SUMMARY

We provide a water heater having a water container, a combustion chamber adjacent the water container, the combustion chamber having an opening that may be covered by a door. The water heater has a burner associated with the combustion chamber and arranged to combust fuel to heat water in the water container and a control valve for regulating fuel flow from an external fuel source. A fuel line extends between the control valve and the burner. The fuel line has a first substantially rigid portion connected to the control valve, a second interior portion extending from the door to the burner and a third flexible portion fixedly connected to both of the first and second portions.

We also provide a water heater having a water container and a combustion chamber having an opening that may be covered by a door and located adjacent the water container. The water heater also has a burner associated with the combustion chamber and arranged to combust fuel to heat water in the water container and a fuel control valve associated with the burner and adapted to control the flow of fuel to the burner for combustion. A fuel line extends between the fuel control valve and the burner. The fuel line has a first tubular substantially rigid portion located adjacent to and fluidly connected with the control valve, a second tubular substantially rigid portion located adjacent to and fluidly connected to the burner and a flexible portion brazed to each of the first and second tubular substantially rigid portions and fluidly connecting the first and second tubular substantially rigid portions. The fuel line fluidly connects the fluid control valve and the burner.

We further provide a fuel line for a combustion water heater. The water heater associated with the fuel line has a fuel control valve, a combustion chamber defined at least in part by an opening that may be covered by a door and a burner located within the combustion chamber. The fuel line has a first tubular substantially rigid portion extending from and fluidly connected to the fuel control valve. The fuel line also has a second tubular substantially rigid portion having a first end fluidly connected to and extending from the burner and a second end located adjacent to the combustion chamber wall. The fuel line also has a flexible portion having a first end fixedly connected to and fluidly connected with the first tubular substantially rigid portion and a second end fixedly connected to and fluidly connected with the second end of the second tubular substantially rigid portion such that the fuel line provides a fluid connection between the fuel control valve and the burner.

### BRIEF DESCRIPTION OF THE DRAWINGS

FIG. 1 is a schematic front elevational view of a water heater.

FIG. 2 is a schematic side view of the water heater of FIG. 1.

FIG. 3 is a perspective view of the lower portion of a water heater of the type shown in FIGS. 1 and 2.

FIG. 4 is a front elevational view of a fuel line assembly of a water heater of the type shown in FIGS. 1 and 2.

FIG. 5 is a side elevational view of the fuel line assembly of FIG. 4.

FIG. 6 is top plan view of the fuel line assembly shown in FIGS. 4 and 5.

FIG. 7 is a perspective view of a partially assembled fuel line and burner mount for a water heater.

FIG. 8 is a perspective view of the fuel line and burner mount for a water heater in a further assembled state.

FIG. 9 is a perspective view of a flange for a water heater fuel line.

FIG. 10 is a perspective view of a flange for a water heater fuel line with a portion of the fuel line inserted therein.

FIG. 11 is a perspective interior view of the fuel line assembly of FIG. 4.

FIG. 12 is a perspective view of the fuel line assembly of FIGS. 4 and 5.

FIG. 13 is an exploded perspective view of a portion of the fuel line assembly of FIGS. 3 and 5.

FIG. 14 is a perspective view of a water heater door of the type shown in FIG. 13.

FIG. 15 is a partial cross-sectional view of the water heater door shown in FIG. 14.

### DETAILED DESCRIPTION

It will be appreciated that the following description is intended to refer to specific aspects of the representative structures selected for illustration in the drawings and is not intended to define or limit the technology of this disclosure, other than in the appended claims.

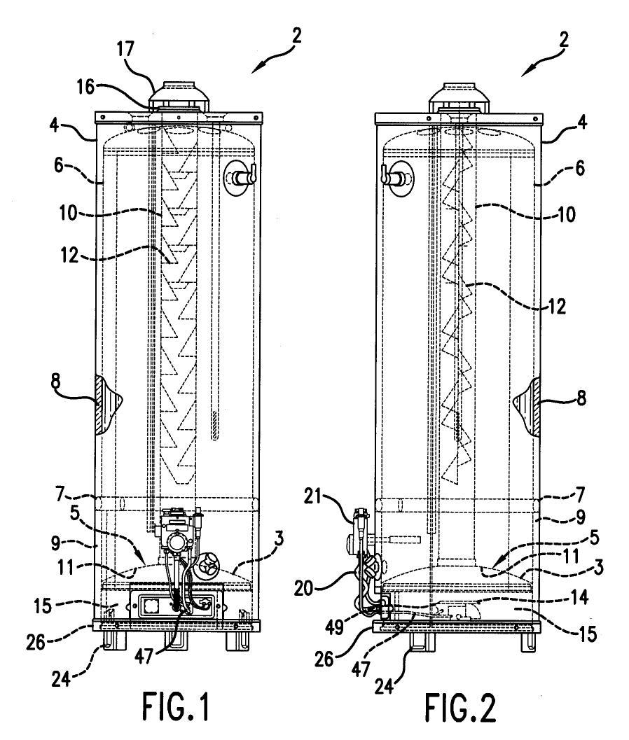

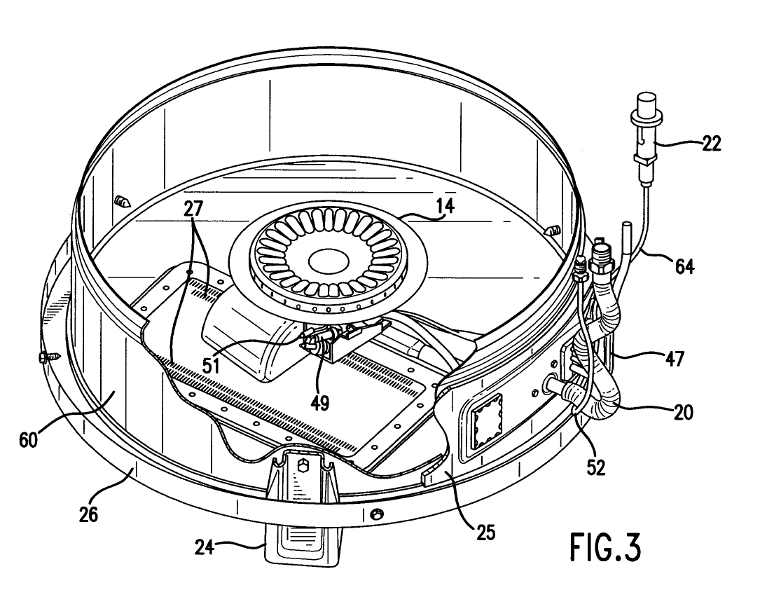

Turning now to the drawings in general and FIGS. 1-3 in particular, the number “2” designates a storage type gas water heater 2. Water heater 2 includes jacket 4 which surrounds a water tank 6, a main burner 14 in a combustion chamber 15. Passing through the center of the tank 6 is a flue 10, in this instance incorporating a series of baffles 12 to better transfer heat generated by the main burner 14. Water tank 6 is preferably of mains pressure capability and is capable of holding heated water. Water tank 6 is preferably insulated by foam insulation 8. Alternative insulation may include fiberglass or other types of fibrous insulation, heating retaining material and the like. Fiberglass insulation 9 surrounds combustion chamber 15 and the lowermost portion of water tank 6. It is possible that heat resistant foam insulation can be used if desired. A foam dam 7 separates foam insulation 8 and fiberglass insulation 9.

Located underneath the water tank 6, within the combustion chamber 15, is the main burner 14 which uses any type of fuel such as oil, natural gas or other gases such as LPG, for example. Other suitable fuels may be substituted. Fuel is provided to the main burner 14 through the main fuel line 20, which is fluidly connected to fuel control valve 21. Fuel control valve 21 supplies fuel to burner 14 by way of main fuel line 20. Main burner 14 combusts a fuel and air mixture wherein combustion air is drawn into combustion chambers through openings 27. The resulting hot products of combustion rise up through flue 10, possibly with heated air. Water tank 6 is lined with a glass or other type of coating for corrosion resistance. Bottom 5 of water tank 6 is preferably coated on both its interior facing surface 3 and exterior facing surface 11. The thickness of the coating of exterior facing surface 11 may be about half of the thickness of interior facing surface 3. Also, the lower portion of flue 10 is preferably coated on both of its opposing surfaces. The surface exposed to the flue gases has a thickness about half the thickness of the surface exposed to water in water tank 6. It has been discovered that the glass coating helps to prevent scaling of the flue and water tank surfaces.

Combustion chamber 15 also contains a pilot burner 49 connected to fuel control valve 21 by pilot fuel supply line 47. A sheath 52, preferably made of copper, containing wires (not shown) from a flame detecting thermocouple 51 to ensure that in the absence of a flame at pilot burner 49 fuel control valve 21 shuts off the gas supply. Thermocouple 51 may be selected from those known in the art. RobertShaw Model No. TS 750U is preferred.

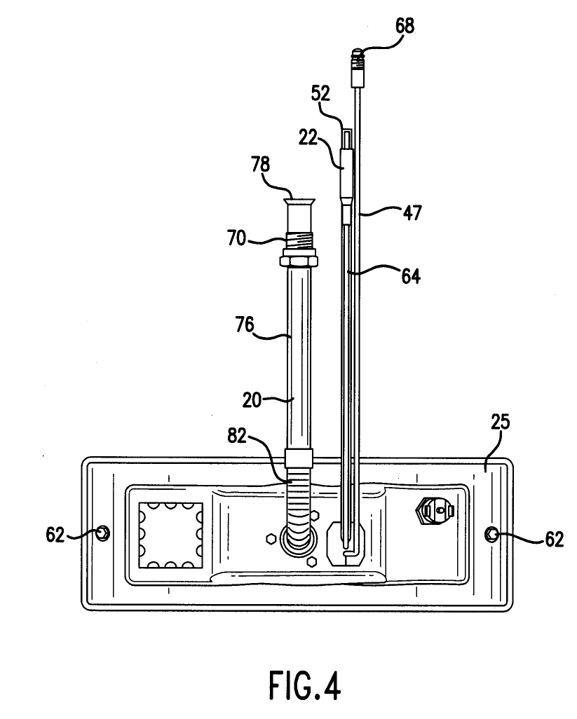

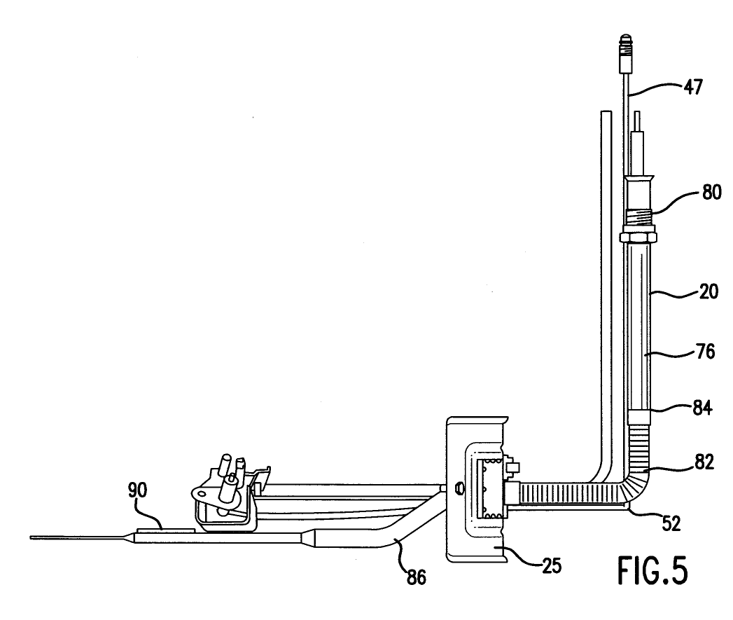

FIGS. 4-6 particularly show main fuel line 20 and pilot fuel supply line 47 extending outwardly from a covering or door 25, which provides access to the combustion chamber 15 through opening 110. Door 25 is removably sealable to skirt 60 that forms the side wall of combustion chamber 15 at opening 110. Door 25 is held into position by a pair of screws 62 or by any other suitable means. Pilot fuel supply line 47 and fuel supply line 20 pass through door 25 in a substantially fixed and sealed condition. Sheath 52 also extends through door 25 in a substantially fixed and sealed condition as does igniter line 64. Igniter line 64 connects on one end to an igniter button 22 and a piezo igniter 66 (see FIG. 5). Igniter button 22 can be obtained from Channel Products, for example. Each of pilot fuel supply line 47, fuel supply line 20 and sheath 52 are removably connectable to fuel control valve 21 by compression nuts 68, 70 and 72, respectively. Each of compression nut 68, 70 and 72 are threaded and threadingly engage control valve 21.

The products of combustion pass upwardly and out the top of jacket 4 via flue outlet 16 after heat has been transferred from the products of combustion. The flue outlet 16 discharges conventionally into a draft diverter 17 which in turn connects to an exhaust duct leading outdoors.

Water heater 2 is preferably mounted on leg 24 to raise bottom pan 26 off the floor. Bottom pan 26 preferably has one or more openings 27 or some other means (not shown) for receiving combustion air. Where bottom pan 26 meets jacket 4, the mating surfaces (made up from surfaces of bottom pan 26 and jacket 4) can be sealed thoroughly to prevent ingress of air or any flammable gas or vapor. The cylindrical wall of jacket 4 (the majority of gas water heaters are cylindrical; however, a cubic or other shaped jacket 4 may be utilized) can be sealed substantially gas tightly so no openings or breaks remain upon assembly and installation.

In particular, gas, water, electrical, control, or other connections, fittings or plumbing, wherever they pass through the jacket 4 or bottom pan 26, can be sealed airtight. The joining area of bottom pan 26 to jacket 4 and all service entries or exits to the jacket 4 need not be sealed airtight. It is preferred, however, that the space around burner 14 be substantially air/gas tight except for means to supply combustion air.

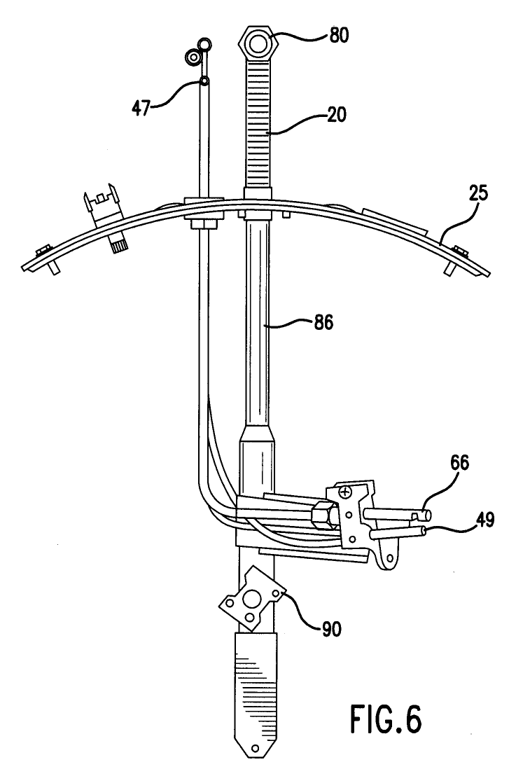

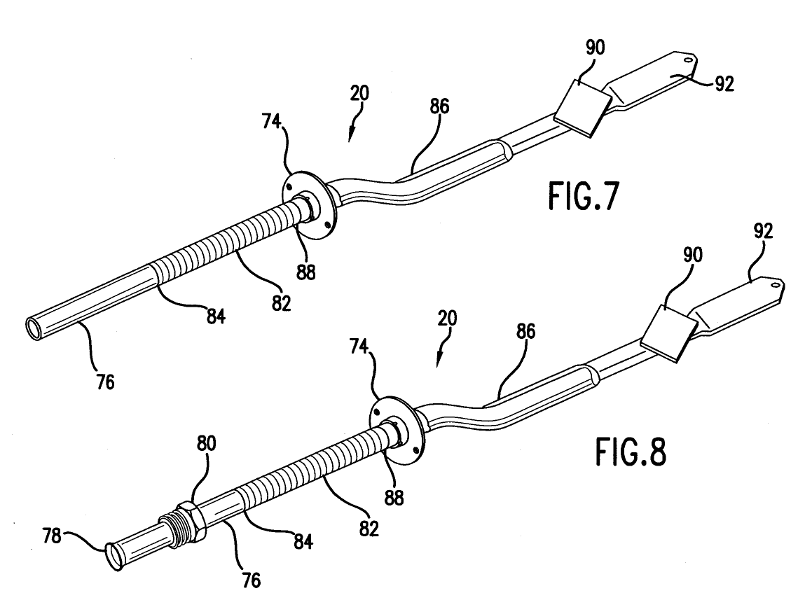

Referring now to FIGS. 4-8, a main fuel line 20 for a water heater 2 is shown. FIGS. 5 and 6 show the main fuel line 20 in connection with a pilot 49 and pilot fuel line 47. FIGS. 7 and 8 show the main fuel line 20 in connection with a mounting portion, such as a flange 74, for mounting the main fuel line 20 to the door 25. The fuel line 20 has a substantially rigid tubular portion 76 located outside of the combustion chamber 15. The substantially rigid tubular portion 76 is adapted to extend downwardly from the control valve 21. The substantially rigid tubular portion 76 is preferably constructed of cold-rolled steel, or a similar material, which provides an economical and strong tube. The substantially rigid tubular portion 76 is connected to the fuel control valve 21 using a compression fitting 70, including a flared portion 78 and a threaded coupling 80. The flared portion 78 may have an inverted double-wall flare, which more readily conforms to the valve seat (not shown) on the fuel control valve 21, providing a strong seal and allowing simpler manufacturing due to the lower tolerances required. A fiber gasket (not shown) is optionally used with the compression fitting to further seal the main fuel line 20 to the fuel control valve 21.

A flexible portion 82 is fixedly connected to the opposite end of the substantially rigid tubular portion 76 from the fuel control valve 21 at a joint 84. The fixed connection refers to a permanent, non removable connection, such as brazing, welding, soldering, crimping or adhering. The precise mechanism of the permanent connection is unimportant so long as it provides sufficient gas tightness, heat resistance and non-removability. The brazed joint 84 replaces traditional (non-fixed) attachment means, such as compression fittings or unions, which are removable and non-permanent. The fixed connection of the brazed joint 84 helps to make the assembly tamper resistant and decreases the need for maintenance.

A second substantially rigid tubular portion, or internal fuel delivery tube 86, extends inwardly from the door 25 to the burner 14. The internal fuel delivery tube 86 is fixedly connected at a joint 88 to the flexible portion 82 to provide a passageway from the fuel control valve 21 to the burner 14. Like the joint 84, joint 88 may be brazed. Providing the brazed joint 88 adjacent the door 25 allows for the use of less rigid material than traditional threaded engagements allows the main fuel line 20 to be positioned close to the jacket 4 of the water heater 2, allowing the production of a more compact product.

Referring now to FIGS. 7 and 8, the main fuel line 20 may have a mounting tab 92 located at an opposing end of the internal fuel delivery tube 86 from the door 25. The mounting tab may be brazed to the main fuel line and is adapted to engage a recess or post (not shown) within the combustion chamber 15 for support of the internal fuel delivery tube 86 and burner 14. The burner 14 is mounted on a burner bracket 90, which is brazed to the internal fuel delivery tube 86.

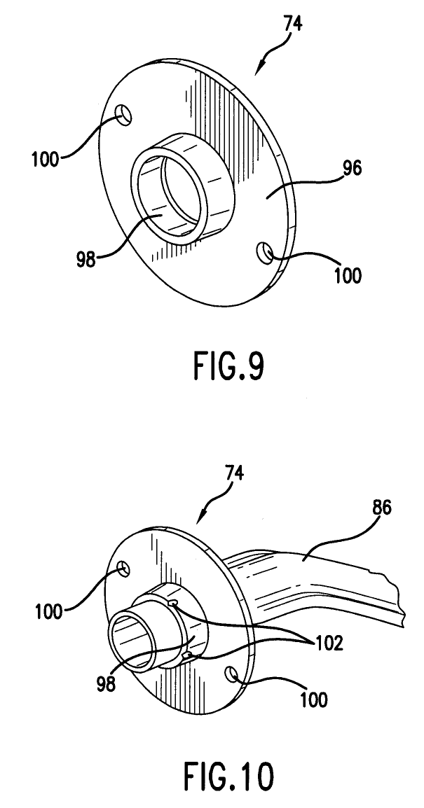

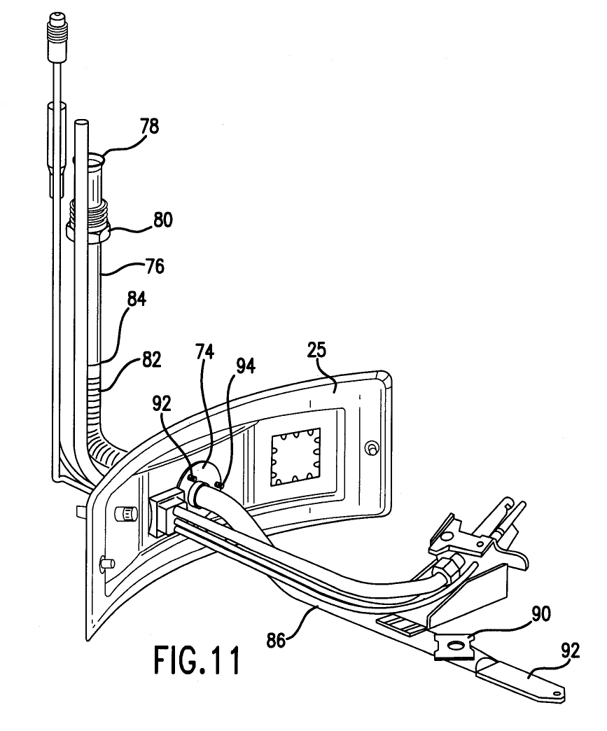

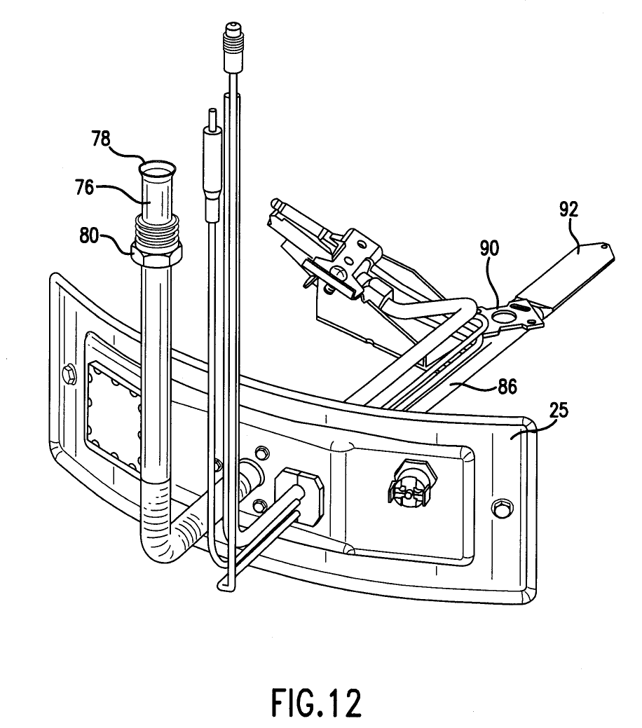

Referring now to FIGS. 9-12, the mounting flange 74 may be either stamped or machined metal, such as a cold-rolled steel. The flange 74 has a flat, disc shaped portion 96 and a ring shaped central portion 98 which defines a passageway in the center of the disc shaped portion 96. The flange 74 is preferably connected to the door 25 using rivets which pass through rivet holes 100, or may be connected by some other attachment means. Prior to brazing the flexible portion 82 to the internal fuel delivery tube 86, the flange 74 is positioned around the internal fuel delivery tube 86 and attached thereto by crimps 102 on the ring shaped portion 98. An optional gasket (not shown) may be used to further seal the flange 74 to the main fuel line 20.

Once the main fuel line 20, along with the flange 74 and mounting tab 92 have been brazed together and leak checked, the entire assembly may be zinc plated to aid corrosion resistance.

Eliminating the larger traditional couplings in favor of brazed joints 84, 88 allows the use of less material in construction. Further, overall material costs are reduced as only a relatively small portion of expensive flexible tubing is used.

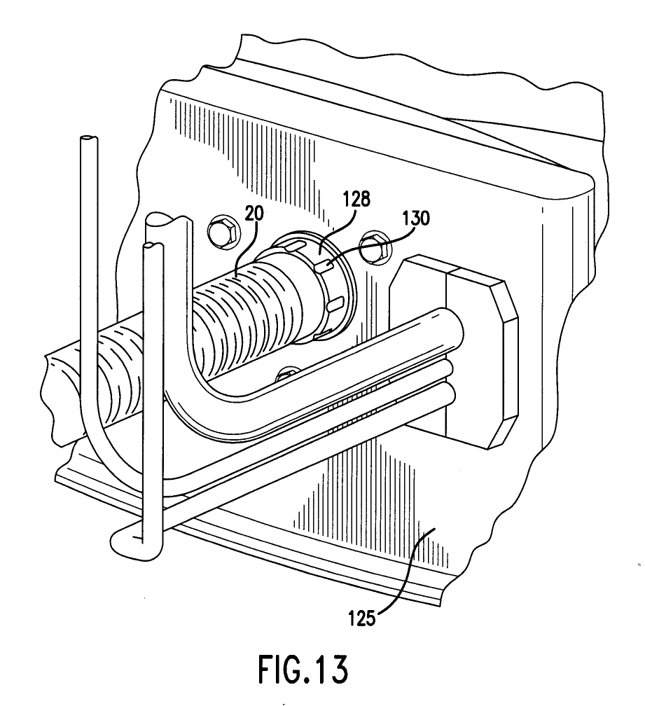

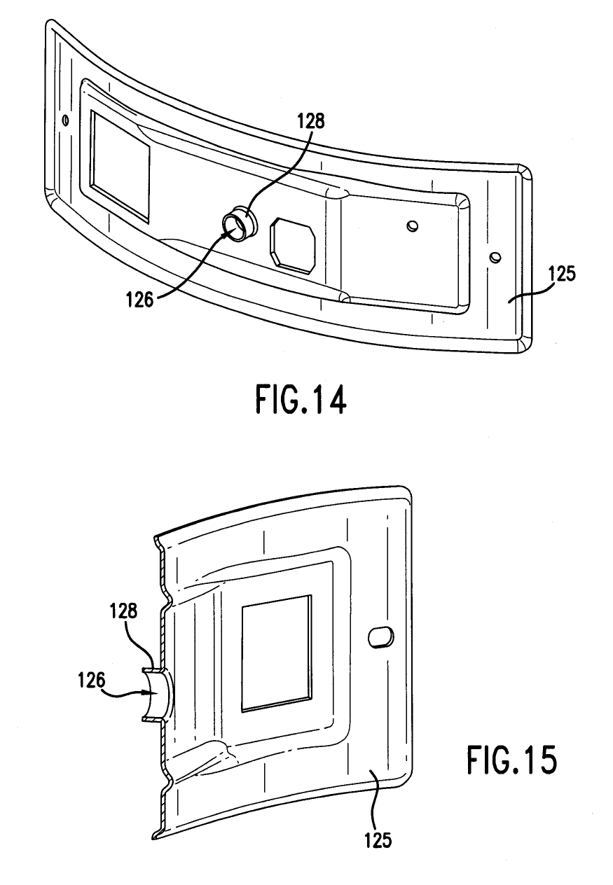

Referring now to FIGS. 13-15, like the door 25 discussed above, a door 125 may also be used. The door 125 has a port 126 extending therethrough and sized to accommodate the main fuel line 20. Unlike the door 25, which is fixed to the main fuel line 20 by means of a flange 74, the mounting portion that secures the main fuel line 20 within the port 126 is a collar 128 which extends outwardly from the door 125. The collar 128 is crimped to the main fuel line 20 at a number of crimp points 130. The collar 128 is of unitary construction with the door 125 and is formed by punching out a hole in the door 125 and pressing the material around the hole into a tubular form.

The size and shape of the various portions can be increased or decreased to suit the application and/or size and/or shape of the water heater. The location of the various conduits relative to the water heater may also be varied depending on the size, shape and location of the water heater. Conversely, the upper portion of the water heater may be the upper half of the water heater, but may be a larger portion so long as the combustion air opening is above the dilution air intake.

It will be understood that water heater 2 may be constructed with a wide variety of materials, in a wide variety of shapes and sizes. For example, any number of types of burners 14 may be employed, along with various types of fuel control valves 21 and the like. Also, various types of insulation, water containers/tanks and jackets may be employed.

Although the technology of this disclosure has been described in connection with specific representative forms thereof, it will be appreciated that a wide variety of equivalents may be substituted for the specified elements described herein without departing from the spirit and scope of this technology as described in the appended claims.

What is claimed is:

1. A water heater comprising:
a water container;
a combustion chamber adjacent the water container, the combustion chamber having an opening that may be covered with a door;
a burner associated with the combustion chamber and arranged to combust fuel to heat water-in the water container;
a control valve for regulating fuel flow from an external fuel source; and
a fuel line extending between the control valve and the burner, the fuel line having a first substantially rigid portion connected to the control valve, a second interior portion extending from the door to the burner and a third flexible portion fixedly connected to both of the first and second portions.

2. The water heater of claim 1, wherein the fixed connections between the third fuel line portion and the first and second fuel line portions comprises brazed joints.

3. The water heater of claim 1, wherein the first substantially rigid fuel line portion is constructed of cold-rolled steel tube.

4. The water heater of claim 1, wherein the third flexible fuel line portion is constructed of flexible stainless steel tubing.

5. The water heater of claim 1, wherein the fuel line passes through a collar extending from the door and secured to the fuel line.

6. The water heater of claim 1, wherein the fuel line passes through a flange mounted to the door and secured to the fuel line.

7. The water heater of claim 1, wherein the combustion fuel line extends through the door into the combustion chamber.

8. The water heater of claim 1, wherein the fuel line is zinc coated.

9. The water heater of claim 1, wherein the first substantially rigid fuel line portion is connected to the control valve using a double-wall flared compression joint.

10. The water heater of claim 9, further comprising a fiber gasket positioned between the fuel line and the control valve and adapted to provide a fluid tight seal between the control valve and the fuel line.

11. A water heater comprising:
a water container;
a combustion chamber adjacent the water container, the combustion chamber having an opening that may be covered by a door;
a burner associated with the combustion chamber and arranged to combust fuel to heat water in the water container;
a fuel control valve associated with the burner and adapted to control the flow of fuel to the burner for combustion;
a fuel line extending between the fuel control valve and the burner, the fuel line having a first tubular substantially rigid portion located adjacent to and fluidly connected with the control valve, a second tubular substantially rigid portion located adjacent to and fluidly connected to the burner, a flexible portion brazed to each of the first and second tubular substantially rigid portions and fluidly connecting the first and second tubular substantially rigid portions such that the fuel line fluidly connects the fluid control valve and the burner, and a mounting portion located on the fuel line adjacent a portion of the fuel line where the second tubular substantially rigid portion is brazed to the flexible portion, said flange adapted for mounting on the door.

12. The water heater of claim 11, wherein the first tubular substantially rigid fuel line portion is constructed of cold-rolled steel tube.

13. The water heater of claim 11, wherein the flexible fuel line portion is constructed of flexible stainless steel tubing.

14. The water heater of claim 11, wherein the first substantially rigid fuel line portion is connected to the control valve using a double-wall flared compression joint.

15. The water heater of claim 11, wherein the combustion chamber wall further comprises a door and the fuel line extends through the door into the combustion chamber.

16. The water heater of claim 15, wherein the mounting portion is crimped to the fuel line prior to brazing the portions of the fuel line together.

17. The water heater of claim 11, wherein the brazed connection between the flexible fuel line portion and the second tubular substantially rigid portion is located adjacent to the door.

18. A fuel line for a combustion water heater, the water heater having a fuel control valve, a combustion chamber defined at least in part by an opening that may be covered by a door and a burner located within the combustion chamber, the fuel line comprising:
a first tubular substantially rigid portion extending from and fluidly connected to the fuel control valve;
a second tubular substantially rigid portion having a first end fluidly connected to and extending from the burner and a second end located adjacent the door; and
a flexible portion having a first end fixedly connected to and fluidly connected with the first tubular substantially rigid portion and a second end fixedly connected to and fluidly connected with the second end of the second tubular substantially rigid portion such that the fuel line provides a fluid connection between the fuel control valve and the burner.

19. The fuel line of claim 18, wherein the first tubular substantially rigid portion is constructed of cold rolled steel and the flexible portion is constructed of flexible stainless steel tubing.

20. The fuel line of claim 18 wherein the flexible portion is fixedly connected to each of the first and second substantially rigid tubular portions by brazed joints.
